(19) United States
(12) Patent Application Publication
(10) Pub. No.: US 2005/0128304 A1
(43) Pub. Date: Jun. 16, 2005

(54) System and method for traveler interactions management

(76) Inventors: Frederick Mark Manasseh, Shoham (IL); Omri Ben-Tov, Kfar-Saba (IL); Zion Hadad, Tel Mond (IL); Jonathan Moav, Ra'anana (IL); Asher Rubel, Shoam (IL)

Correspondence Address: NEEDLE & ROSENBERG, P.C., SUITE 1000, 999 PEACHTREE STREET, ATLANTA, GA, 30309-3915, US

(21) Appl. No.: 10/506,368

(22) PCT Filed: Mar. 6, 2003
(86) PCT No.: PCT/IL03/00186

Related U.S. Application Data
(60) Provisional application No. 60/354,209, filed on Feb. 6, 2002.

(30) Foreign Application Priority Data
Dec. 26, 2002 (IL) PCTIL0201042

(51) Int. Cl. H04N 5/225

(52) U.S. Cl. 348/207.99

(57) ABSTRACT

An apparatus and method for the analysis of a captured interaction associated with a traveler and an agent, the apparatus comprising an at least one first station for capturing an at least one first interaction along a traveler path, an at least one second station for capturing an at least one second interaction along the traveler path and an analysis device for comparing the at least one second interaction with the at least one first interaction.

### RELATED APPLICATIONS

The present invention relates to and claims priority from U.S. provisional patent application Ser. No. 60/362,309 for A SYSTEM AND METHOD FOR TRAVELER INTERACTION MANAGEMENT, filed on 7 Mar. 2002.

PCT patent application number PCT/IL02/00593 for METHOD, APPARATUS AND SYSTEM FOR CAPTURING AND ANALYZING INTERACTION BASED CONTENT, filed 18 Jul. 2002; PCT patent application number PCT/IL02/01042 for SYSTEM AND METHOD FOR VIDEO CONTENT ANALYSIS-BASED DETECTION, SURVEILLANCE, AND ALARM MANAGEMENT, filed 24 Dec. 2002; PCT patent application serial number PCT/IL03/00097 for METHOD AND APPARATUS FOR VIDEO FRAME SEQUENCE-BASED OBJECT TRACKING, filed 6 Feb. 2003; PCT patent application serial number PCT/IL02/00197 for SYSTEM AND METHOD FOR CAPTURING, ANALYZING AND RECORDING SCREEN EVENTS, filed 12 Mar. 2002; PCT patent application serial number PCT/IL01/00796 for SYSTEM AND METHOD FOR CAPTURING BROWSER SESSIONS AND USER ACTIONS, filed 24 Aug. 2001; PCT patent application serial number PCT/IL02/00741 for RECORDING AND QUALITY MANAGEMENT SOLUTIONS FOR WALK-IN CENTERS, filed 5 Sep. 2002; are related to the present invention and are incorporated herein by reference.

### BACKGROUND OF THE INVENTION

1. Field of the Invention

The present invention relates to audio, video and data recording and retrieval, to real-time data management, to security systems in general, and to a system and method for traveler interactions management, in particular.

2. Discussion of the Related Art

Worldwide civil aviation security related incidents are on the rise. A US government report concerning criminal acts against civil aviation lists 42 significant attacks in the year 2000 alone, the highest number of attacks in one year recorded since 1994. According to this report, in a period of five years ending the year 2000 thirty attacks occurred inside airports. Other attacks include hijacking, robbery, bombing, commandeering, and shootings. On Sep. 11, 2001 a group of terrorists hijacked a number of civilian airplanes and crashed them into the World Trade Center buildings in New York. A significant number of lives perished in this attack. In the wake of this attack new laws were passed to curtail terrorist activities and a new US government office for Homeland Security was established to strengthen US defenses from foreign threats. This attack exposed the many loopholes in the security of civil commercial air transportation. Such include the inability of governmental organizations as well as civil authorities to identity and determine the whereabouts of passengers boarding aircrafts at the airport or other vehicles of transport in bus depots and train stations. In wake of the events of September 11, a US White House Commission on Aviation and Security concluded that the US Federal Aviation Authority (FAA) should establish a security system that will provide a high level of protection for all aviation information systems. The same commission also suggested that the FAA should work with airlines and airport consortia to ensure that all passengers are positively identified and subjected to security procedures before they board aircraft.

The process of traveling by air begins with purchasing a ticket and continues through certain service stations in the embarkation airport, prior to the flight itself and in additional service and control stations in the destination airport. Most of the service and control stations are manned by agents, such as a travel agents, check-in agents, security personal, border control officers, ground attendants and the like. Some of these agents are already equipped with passive monitoring or other devices, such as computers. The interaction between traveler and agents occurs, for example, in the following service stations: 1. Ticket purchase—performed at the travel agent, by purchase of an e-ticket on the World Wide Web data communications network, airport ticketing counters; 2. Check-in counters, including curbside counters and VIP check-in; 3. Check-in security—conducted by a check-in agent; 4. Passport control—conducted by border control officers; 5. Passenger and hand luggage screening; 6. Baggage screening; 7. Boarding gates; 8. Baggage claim; 9. Immigration control; 10. Customs; 11. Transfer counters; and the like. Presently all these service stations operate independently of each other (except ticketing) and data, available or accumulated from the interactions with the traveler is not shared by all the relevant parties interacting with the travelers. The traveler is not identified and verified at each service station, and no verification is accomplished against available external databases. Furthermore, no single location exists where traveler-interactions-specific collections of information are recorded for real-time monitoring or for off-line debriefing.

As a result agents are not alerted in case of traveler discrepancies, which might have grave implications on travel safety. Currently, it is practically impossible to trace a specific traveler's route through airports, bus depots, train stations and the like and in general security depends solely on the quality and performance of agents responding to a single interaction. Since video or audio monitoring is not available at the service and control stations of travel, recording of traveler-agent interactions is impossible, which results in lack of real-time data, limited evaluation of agent's performance for quality assurance and limited agent training capabilities on real-time situations.

There is therefore a need for a system and method that will overcome the deficiencies of the prior art by providing a system and method for traveler interactions management. Such a system would preferably automate the procedure concerning the agent-traveler interaction, will preferably require identification of the traveler, log such interactions, analyze the interactions, resolve any discrepancies and alert users, agents or law enforcement agencies. Such a system would further utilize advanced traveler tracking methods that would provide the option of tracking travelers for an operationally effective period and would continue tracking objects in an efficient manner even where the tracked object is occluded.

### SUMMARY OF THE PRESENT INVENTION

One aspect of the present invention regards an apparatus for the analysis of a captured multi-media interaction associated with a traveler and an agent, the apparatus comprising an at least one first station for capturing an at least one first interaction along a traveler path, an at least one second station for capturing an at least one second interaction along the traveler path; and an analysis device for comparing the at least one second interaction with the at least one first interaction. The apparatus further includes a locally or remotely located control station for storing the at least one first and second interactions captured. The apparatus also includes an alarm identifier device for identifying an alarm situation based on the comparing of the at least one second interaction with the at least one first interaction. The apparatus further comprises an alarm-generating device for generating an alarm associated with an alarm situation identified by the alarm identifier device. The apparatus further comprises a station poll data device for polling stations for the at least one first and second interactions. The apparatus is also connected to a database for storing and retrieving the at least one first and second interactions. The apparatus also includes a replay device for replaying at the least one first or second interactions. The apparatus further comprises an object tracking device for tracking an object within the at least one first or second interactions. The at least one first and second stations comprise at least one video capturing device, an at least one audio recording device, an at least one data capture device, an at least one storage device and an at least one data retrieval device. The at least one first station and second station are located in the same transportation port. The at least one first station and second station are located in remote transportation ports. The apparatus further comprises a control room for recording and storing the at least one first and second interactions. The apparatus further comprises a local or remote operator for observing the operation of the apparatus. The control station comprises a recording and retrieval system. The capturing is performed in real time to be analyzed upon capture or at a later time. The transportation port can be an airport or a train station or a bus depot or a seaport or a any other type of vehicle for transporting persons. The interaction is associated with a traveler or a baggage item. The at least one and second interactions comprise a captured data, video and audio depicting the interaction between the agent and the traveler. The apparatus also comprises a quality assurance device for analyzing the at least one first or second interaction for analyzing the quality of service provided to the traveler by the agent. The quality assurance device alerts a supervisor where the quality of service provided by an agent fails to meet a predetermined standard. The quality assurance device initiates a training session for an agent. The apparatus further comprises a station transfer data device for managing data transferred from stations for the at least one first and second interactions.

A second aspect of the present invention regards a method for the analysis of a captured interaction associated with a traveler and an agent, the method comprising the steps of capturing an at least one first interaction at a first station along a traveler path, capturing an at least one second interaction at a second station along the traveler path, and comparing the at least one second interaction with the at least one first interaction. The method further comprises the step of recording at a control station the at least one first and second interactions captured. The method further comprises the step of storing at a control station the at least one first and second interactions captured. The method also includes the step of an alarm identifier device identifying an alarm situation based on the comparing of the at least one second interaction with the at least one first interaction. The method further comprises the step of generating an alarm associated with an alarm situation identified by the alarm identifier device. The method further comprises the step of polling the at least one first and second interactions from the first and second stations. The method further comprises the step of retrieving the at least one first and second interactions from a database. The method further comprises the step of replaying through the use of a replay device the at the least one first or second interactions. The method further comprises the step of tracking an object within the at least one first or second interactions. The method further comprises the step of analyzing the at least one first or second interaction for quality assurance purposes. The at least one first station and second station are located in the same transportation port. Alternatively, the at least one first station and second station are located in remote transportation ports. The method further comprises the step of recording and storing at a second control room the at least one first and second interactions. The step of analysis comprises comparing the at least first or second interaction to determine discrepancies in the interaction between the traveler and the agent. Alternatively, the step of analysis comprises comparing the at least second interaction with the at least first interaction to determine discrepancies between the second and first at least one interactions. Alternatively, the step of analysis comprises analysis of the at least first or second interaction to determine whether the traveler is a security threat to other travelers. The step of analysis can also comprise analysis of the at least second or first at least one interaction to determine if the agent is providing a quality of service at a predetermined level. The method further comprises the step of transferring data from a station to a server device.

### BRIEF DESCRIPTION OF THE DRAWINGS

The present invention will be understood and appreciated more fully from the following detailed description taken in conjunction with the drawings in which:

FIG. 1 is a schematic block diagram of the system architecture, in accordance with a preferred embodiment of the present invention;

FIG. 2 is a semi-pictorial representation of service and control stations for the processing of departing travelers, in accordance with the preferred embodiment of the present invention;

FIG. 3 is a semi-pictorial representation of additional service and control stations for the processing of arriving travelers, in accordance with the preferred embodiment of the present invention;

FIG. 4 shows the components of an exemplary service and control station, in accordance with a preferred embodiment of the present invention;

FIG. 5 depicts the components of a recording and retrieval system, in accordance with a preferred embodiment of the present invention;

FIG. 6 shows the structure and components of a computing device utilized for the implementation of the recoding and retrieval system, in accordance with a preferred embodiment of the present invention;

FIG. 7 depicts an exemplary structure of the database associated with the recording and retrieval system, in accordance with a preferred embodiment of the present invention;

FIG. 8 shows the modules of the application program, in accordance with a preferred embodiment of the present invention; and

FIG. 9 shows an exemplary flow chart of the operation of the application program, in accordance with a preferred embodiment of the present invention.

### DETAILED DESCRIPTION OF THE PREFERRED EMBODIMENT

The present invention provides for a system and method for traveler interactions management. The invention discloses a system and method according to which data, audio, and video comprising information is captured at specific locations along the traveler's path. The information is recorded in real-time or if real-time recording is not possible, near real-time recording is performed. The information can be accessed in real-time or can be analyzed off-line in order to establish the route the traveler has passed and the handling of the traveler by each agent along the travel path. The system can be used over a long span of time (from one travel segment to months and even years) during which traveler interactions are recorded and managed. The system analyzes and may allow access to historical information, such as captured traveler profile, associated identification information, traveler preferences, and the like, recorded in reference to a specific traveler. Travelers can perform numerous interactions with the system and each will be recorded and placed in the system's database and analyzed. While the present invention describes such interactions within an airport and an aircraft, it will be appreciated by those skilled in the art that such interactions can be managed in other travel junctions and vehicles of transportations, including for example in sea ports, bus and train stations, taxi stations, underground trains, ships, cars, trains, and the like. For the capturing of data, audio and video current or prospective computerized systems are used to obtain information about travelers. The systems used may include personal computers, video and other cameras, microphones, scanners, hand held and mobile device, systems for baggage and passenger management, security systems such as metal detectors and the like. Agents may use computers to enter diverse relevant information about each traveler; and agents may provide positive identification of passengers at certain points along the path of the passenger. Traveler information entered into computers is captured while keyed-in through the operation of a screen event capture software module and stored in a suitable manner. Other system such as the video and audio systems will capture the interaction between the agent and the passenger. Video and other cameras may also capture the appearance of the passenger as well as other important features, such as his texture, cloths, demeanor, accompanying persons, size, and appearance of baggage and other information, which may be captured by cameras. Cameras may include standard video cameras or other cameras capturing heat emission or the like. The interaction may also include the conversation between the agent or officer and the passenger. The audio recording may include the voice of the passenger for real-time identification or for off-line analysis. Similarly, the agent's interaction with the various software systems used in the port or vehicle will also be captured both for analysis and quality assurance to determine quality of service. The agent or officer may also be asked to enter additional information concerning the passenger, such as a personal information, answers to predetermined, such as security-related questions, and any other information pertinent to the later identification and follow up of the interaction. The various captured multi-media content along the path of the traveler is recorded locally or remotely and may be used in real time or off-line for analysis or for quality assurance purposes. The ability of the system and method of the present invention to follow each traveler from that point in time at which a ticket of travel is purchased until the point in time at which the travelers' final destination, such as a hotel at the port of arrival, is reached, enables law enforcement agencies as well as civil authorities, travel companies and carriers to locate, identify, and analyze each or part or all of the interactions. Such will also assist in creating a profile for the traveler. A profile for the traveler may be used for a plurality of trips and for analysis in real time or off line of the profile. Links between travelers may be easily established. Similarly, links between baggage and one or more travelers or persons may also be easily established. The system and method are operative across a plurality of countries, regions and ports of travel. It may be extended to hotels, vehicles of transportations (airplanes, ships, and the like), and other locations where traveler-agent interactions exist and may be captured. Monitoring in real-time for discrepancies can detect suspicious signs and may generate an alarm to specific personnel. Furthermore, the performance of off-line analysis assists in the reconstruction of the traveler's diverse interactions in order to enrich the profile information of the traveler, and in order to provide the option of producing reports, and high-level statistical analysis.

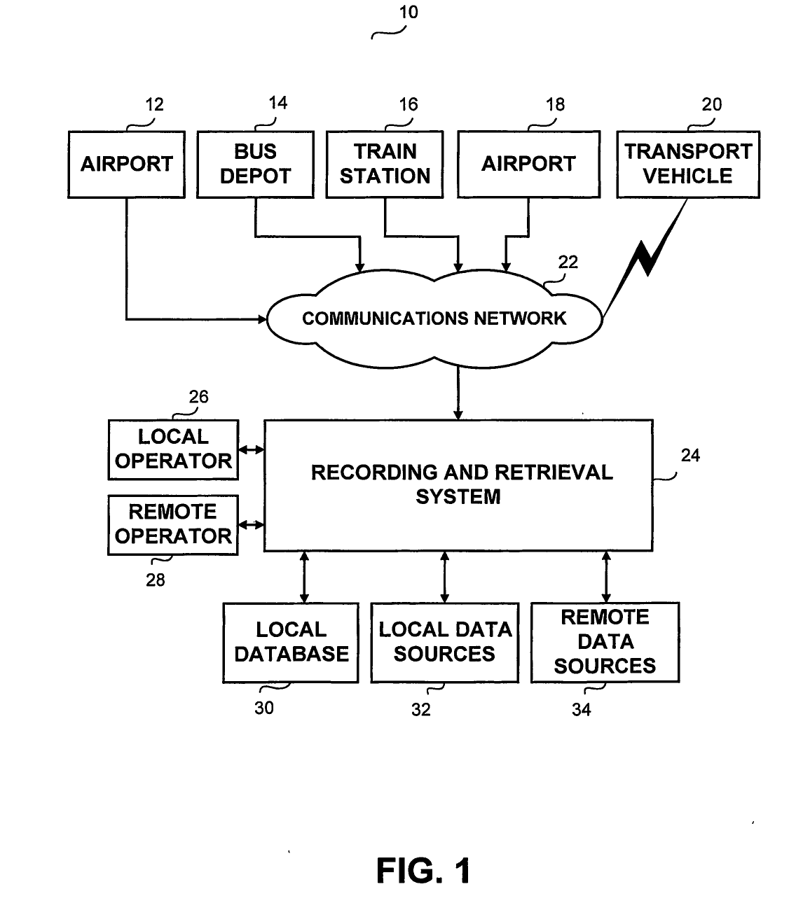

Referring now to FIG. 1 wherein the system of the present invention is disclosed. The system comprise a plurality of major interaction capturing locations located in various travel and transportation locations or vehicles, such as airports, sea ports, bus depots, train stations, vehicles and the like. Each major interaction capture location may comprise a plurality of interaction capturing locations; such as various service and control stations distributed across the major interaction capture location. Each service and control station may include a computer such as a personal computer or the like, video and/or audio capturing devices such as a video camera and a microphone. The various capturing locations may be located in various states, as well as in various countries around the globe. Thus in a typical major interaction capture location, such as an airport, multiple interaction capturing stations may be located along the path of an embarking or disembarking traveler.

Still referring to FIG. 1, major interaction capturing locations 12, 14, 16, 18, 20 are transportation hubs, transportation vehicles, and travel agencies that may include one or more interaction capture locations, such as service stations with control capabilities. Thus, location 12 is a first airport, location 14 is a bus depot, location 16 is a train station, location 18 is a second airport, and location 20 is a transportation vehicle. Each of locations 12, 14, 16, 18, 20 may include one more interaction capture stations. In a travel agent office, a bus depot, a train station, and the like, such stations could include point of sales for ticket ordering and selling. In an airport or seaport such stations could include passport control, custom control, check-in counters, baggage screening, and the like. In a transportation vehicle such stations could include a boarding point, a passenger cabin, and the like. The major interaction capturing locations 12, 14, 16, 18, 20 are linked through a communications network 22 to a recording and retrieval system 24. The system 24 could be located at one or more major interaction capture locations, such as one or more airports. The system 24 could be further located in an independent location. The system 24 typically includes a computer, recording and monitoring devices operated locally and remotely by human operators 26, 28. The system 24 is capable of accessing a local recoding and retrieval database 30, further relevant local data sources 32, such as flight information, screening machines database, control tower information, and the like, and remote data sources 34, such as databases or on line information installed on remote recording and retrieval systems and the like.

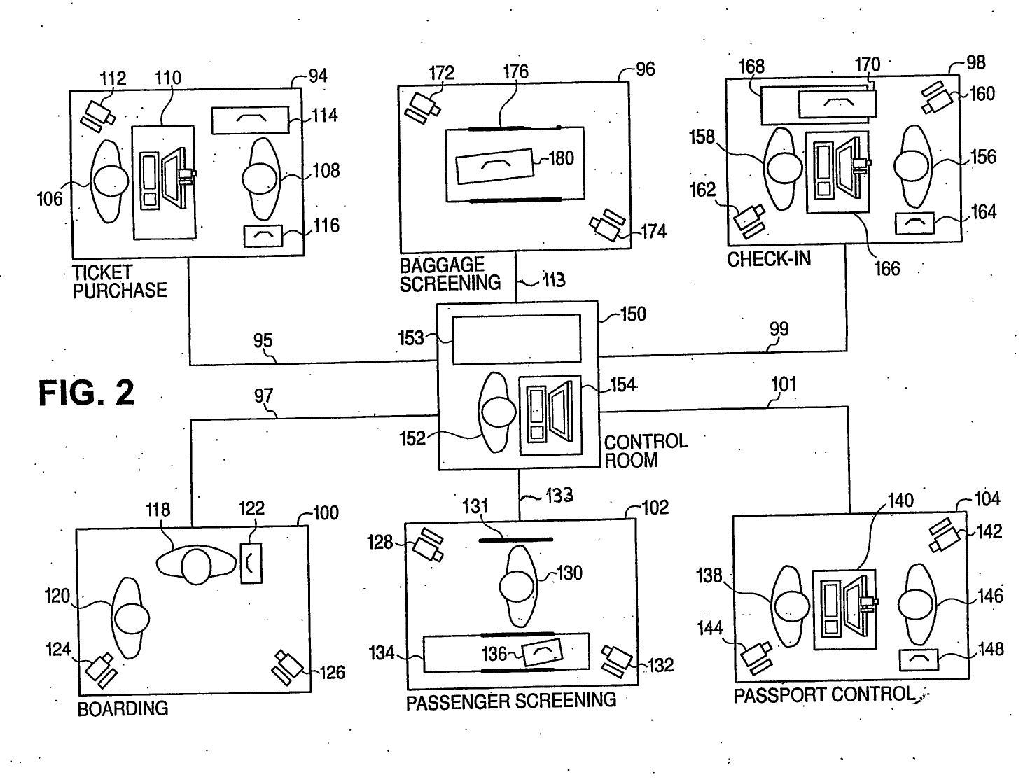

Referring now to FIG. 2 that illustrates a group of interaction capturing stations in a commercial airport or transportation port. The stations 94, 96, 98, 100, 102, 104 are service and control stations, which are suitably distributed along an exemplary “departure” lane for embarking travelers. The stations are operative in the handling of embarking travelers where the handling includes the provision of specific services for the travelers, the implementation of specific legal and administrative rules, and for the provision of security through the successive monitoring of the agent-traveler-baggage interaction. The traveler is required to pass the stations 94, 96, 98, 100, 102, 104 in order to interact with the appropriate service and administrative agents that are responsible for the implementation of the specific legal and administrative rules allowing travel. The stations 94, 96, 98, 100, 102, 104 are typically manned by service or administrative agents or security or control agents. The stations 94, 96, 98, 100, 102, 104 include various service-oriented and administration-oriented devices or various security-oriented devices where some devices are useful for both service and control functions. These devices typically include computing devices with associated display screens, keyboards, microphones, and communication devices. Additional devices include video capturing devices, such as cameras, and the like. Most such devices may connect to local or wide area networks as well as to the Internet. The devices may connect to an Intranet or wireless communications networks.

Still referring to FIG. 2, station 94 is an exemplary point of sale for the purchase of travel arrangements such as airline tickets in a commercial airport. The station 94 is manned by a ticket agent 106. The agent 106 operates a computing device 110. The device 110 is typically a desktop computer with associated input and output devices, such as display screen, keyboard, pointing device, and microphone. The agent 106 interacts with the traveler 108 and enters the information acquired during the interaction into the device 110. Such information may include for example, the name of the traveler, his identification documents particular, destination or destinations of travel, credit and financial information, whether he/she travels alone, the length of trip and the like. In accordance with the present invention, irrespective with the station 94 ordinary software, additional capturing software specially installed on computer 110 will capture the information, screens, audio, and data exchanged between the traveler 108 and agent 108. More detailed description of the interaction and the data capture method is provided in the related PCT application serial number IL/02/00741 titled RECORDING AND QUALITY MANAGEMENT SOLUTIONS FOR WALK-IN ENVIRONMENTS and in the related PCT application serial number IL/02/00593 for METHOD, APPARATUS AND SYSTEM FOR CAPTURING AND ANALYZING INTERACTION-BASED DATA incorporated herein by reference. The information is suitably formatted into computer-readable traveler data and is sent via a communication line 95 to the control room 150 in order to be recorded, processed, stored, monitored, and retrieved where needed. Alternatively the information captured may be sent to a remote control room or to a local or remote computer device located in the same area or alternatively located in a remote and alternative site, via hard-wired line, cellular means, radio or wireless means, including satellite and other wireless means. The information may also be sent to a redundancy system for the purpose of securing such recording. Station 94 further includes a video camera 112 that record a set of sequentially ordered video images that capture the agent-traveler interaction. Thus, the set of images capture the visual characteristics of the traveler, such as clothing, hair color, items carried (baggage pieces 114, 116) and the behavior patterns of the traveler 108. The captured sequence of images is transmitted via the communication line 95 to the control room 150 in order to be integrated with the traveler's 108 other data.

Still referring to FIG. 2 station 98 is a check-in point. Station 98 is manned by a check-in agent 158 equipped with a computing device 166. The device 166 is equipped with various input/output devices, such as a display screen, a keyboard, a pointing device and the like. The check-in agent 158 interacts with a traveler 156 and enters the information resulting from the interaction into the computing device 158 for purposes of validation, verification, storage and security checks. At this stage, the traveler would ordinarily present the travel documents purchased from the travel agent. The traveler would also present identification documents and would have to answer a number of questions such as which seat in the vehicle of transportation he desires. Additional questions would be directed to the traveler to ascertain the traveler is not a security risk. During such questioning the recoding of the traveler may prove to be instrumental in identifying both discrepancies between information collected at station 94 at station 98 and also between the questions presented to the documents already presented now in past interactions. Discrepancies may also be identified in relation to previous behavior or information provided during interactions in previous trips. The information is suitably formatted to computer-readable data and sent to a control room 150 via communication line 99 to be recorded, processed, integrated, stored and connected to the specific traveler 156 record. The station 98 further includes a baggage weight-measuring device 168 to measure the weight of the baggage 170 belonging to traveler 156. Several image acquiring devices, such as video cameras 160, 162 capture a sequentially ordered sequence of images visually reflecting the agent-traveler interaction. The captured sequence of images show the visual characteristics of the traveler 156, such as physical size, hair color, clothing, the baggage checked-in 170, personal items carried (handbag 164) as well as the behavior patterns of the traveler 156, and the like. A detailed description of the capturing capabilities of the system in accordance with the present invention is further detailed described in the related PCT application number PCT/IL02/01042 for SYSTEM AND METHOD FOR VIDEO CONTENT ANALYSIS-BASED DETECTION, SURVEILLANCE, AND ALARM MANAGEMENT, filed 24 Dec. 2002 and in the related PCT application serial number PCT/IL03/00097 for METHOD AND APPARATUS FOR VIDEO FRAME SEQUENCE-BASED OBJECT TRACKING, filed 6 Feb. 2003 incorporated herein by reference. The captured video mages are sent via the communications line 99 to the control room 150 in order to be processed, integrated, stored and optionally retrieved. Audio capture devices, such as a microphone capture an audio record of the agent-traveler interaction and the audio stream is sent via communication line 99 to the control room 150 or to other locations in order to be recorded, processed, to be integrated with the traveler's 156 record, to be stored and to be retrieved where needed. The audio interaction may be analyzed together with other information and data or independently. Station 96 is a baggage screening point that includes an X-ray device 176 or like device having the ability to determine if certain devices or substances such as explosives are placed in the baggage. The device 176 screens the baggage 180. Current screening devices may include a database for the storage of the results of the screening process. Station 96 further includes several video cameras 172, 174 that record a set of sequentially ordered video images. The sequence of captured images reflects the visual characteristics of the baggage 180. The captured sequence of video images, along with the information stored in the database of the screening device 176, is sent via communication line 103 to the control room 150 or to other locations in order to be recorded, processed, and to be associated with a specific traveler's record. The capture of the internal and visual or other attributes of the traveler's baggage is of import in order to identify whether the baggage is a security risk and in order to associate a particular traveler with his or hers baggage. This additional station may be instrumental in aiding the identification of security hazards as well as locating lost baggage.

Station 104 is a passport control point. Station 104 is manned by a passport-checking officer 138 equipped with a computing device 140. The device 140 is equipped with various input/output devices, such as a display screen, a keyboard, a pointing device and the like. The passport-checking agent 158 interacts with a traveler 146 and enters the information resulting from the interaction into the computing device 140 for purposes of validation, verification, storage and security checks. The traveler would present this officer with the same travel documents shown earlier. Passport control officers are also equipped with computing devices having access to national or international databases including information about travelers'departures and arrivals into the country they are in. The information is suitably formatted to computer-readable data and sent to a control room 150 or to a remote location via communication line 101 to be processed, integrated with the traveler 146 record, recorded, stored and optionally retrieved. The station 104 further includes several image acquiring devices, such as video cameras 142, 144 that capture a sequentially ordered sequence of images visually reflecting the agent-traveler interaction. The captured sequence of images show the visual characteristics of the traveler 146, such as facial features, physical size, hair color, clothing, personal items carried (handbag 148) as well as the behavior patterns of the traveler 146. The captured video mages are sent via the communications line 101 to the control room 150 or to a remote location in order to be processed, to be integrated with the traveler 146 record, to be recorded, stored and optionally to be retrieved. Audio capture devices, such as a microphone capture an audio record of the agent-traveler interaction. Reference is made to the detailed description of the interaction and the data capture method provided in the related PCT application serial number PCT/IL02/00741 for RECORDING AND QUALITY MANAGEMENT SOLUTIONS FOR WALK-IN CENTERS, filed 5 Sep. 2002 incorporated herein by reference. The the audio stream is sent via communication line 101 to the control room 150 or to a remote location in order to be processed, to be integrated with the traveler's 146 record, to be recorded, stored and to be retrieved where needed. As with other stations, the information captured may be analyzed on line and in real time to identify discrepancies in the traveler's documents, information provided, demeanor and behavior, appearance, hand bag, party and the like. The capture of such interactions and the ability to supervise the officers in real time may also assist a supervisor of the officers to better handle large amounts of travelers and avoid long lines.

Still referring to FIG. 2 station 102 is a traveler screening point. Station 104 includes an X-ray screening device 134 or like device operative in the screening of the baggage 136 belonging to traveler 130 and identifying the content thereof without effectively opening baggage 136. Station 104 further includes a body-screening device to screen the body of traveler 130 in order to examine the presence of items forbidden to carry during travel. The station 102 further includes several image acquiring devices, such as video cameras 128, 132 that capture a sequentially ordered sequence of images of the traveler 130 and the baggage 136. The captured sequence of images show the visual characteristics of the traveler 130, such as facial structure, physical size, hair color, clothing,. personal items carried as well as the behavior patterns of the traveler 130. The captured video mages are sent via the communications line 133 to the control room 150 or a remote location in order to be processed, to be integrated with the traveler 130 record, to be recorded, stored and optionally to be retrieved. Station 100 is a boarding point. A boarding agent 120 mans station 100. The boarding agent 120 interacts verbally with a traveler 146, and examines and verifies the relevant boarding documents. The station 100 further includes several image acquiring devices, such as video cameras 124, 126 that capture a sequentially ordered sequence of images visually reflecting the agent-traveler interaction. The captured sequence of images show the visual characteristics of the traveler 118, such as facial characteristics and appearance, physical size, hair color, clothing, personal items carried (handbag 122) as well as the behavior patterns of the traveler 118. The captured video images are sent via the communications line 97 to the control room 150 or to a remote location in order to be recorded, processed, to be integrated with the traveler 118 record, to be stored and optionally to be retrieved. A more detailed description of the system for capturing the scene of a walk-in location is further detailed in the related PCT patent application serial number PCT/IL02/00741 for RECORDING AND QUALITY MANAGEMENT SOLUTIONS FOR WALK-IN CENTERS, filed 5 Sep. 2002. Optionally installed audio capture devices, such as a microphone (not shown) capture an audio record of the agent-traveler interaction and the audio stream is sent via communication line 97 to the control room 150 or to a remote location in order to be recorded, processed, to be integrated with the traveler's 118 record, to be stored and to be retrieved where needed. The traveler 118 may be monitored when he boards or disembarks a vehicle such as an airplane via the capture devices located on board such vehicle. Likewise the traveler may be monitored during boarding until he reaches his allotted seat, thus eliminating the need to manually account for his location on the vehicle. In case the traveler is missing or is not located in his allotted seat at a designated time the system of the present invention will alert a predetermined person such as the cabin crew or security officers.

Still referring to FIG. 2 the control room 150 is manned by a system operator 152. The system operator may be a security officer or law enforcement officer or an operator. The control room 150 includes a computing and communications platform device 153 and an associated display and input device 154. Captured data from the stations 94, 96, 98, 100, 102, 104 is transmitted to the control room and recorded and stored in the computing and communicating device 153. The operator 152 monitors the activity of the system by the display device and interacts with the system via the input device 154 and the computing and communicating device 153. The interaction could include defining and introducing system parameters, monitoring the proper operation of the system, activating or de-activating some or all of the components of the system, controlling such devices through tilt stream rate setting and the like, selectively monitoring the audio or data sent by a specific video camera or microphone respectively, responding to an alarm notification in pre-defined manner, setting thresholds, calibrating the control and data gathering (for example according to bandwidth loads, site characteristics, customer preferences, and the like), communicating with the various service and control stations, communicating with external resources such as law enforcement agencies, and the like. The control room may be located in the same transportation junction as stations 94, 96, 98, 100, 102, 104 or remotely to such stations. The stations 94, 96, 98, 100, 102, 104 connected to. control room 150 via communication lines 95, 97, 99, 101. Communication lines 95, 97, 99, 101 may include a hardwire connection or cellular connection. The connection may be an IP based connectivity, wireless, satellite or radio or like connections. The stations may be connected to control room 150 via a local area network or a wide area network or like communication network, including the Internet. Secure link from each station to the control room would be preferred. Each of stations 94, 96, 98, 100, 102, 104 in addition to be used as a station for capturing information may receive alerts, in response to predetermined events defined as raising suspicion or as unpredicted behavior, or discrepancy information as well as information and data relating to the traveler which would not have been available to any one such station. For example, the passport control station 104 may receive information about the departure time of the traveler 146, as well as his port of destination and an image of the traveler's handbag 148 as taken by previous capturing devices including devices 112, 172, 176, 160, 162. While not mentioned each computer terminal associated with an agent may have a small video camera thereon in order to capture the likeness of the traveler. Persons skilled in the art will appreciate the additional and various abilities of the proposed connection between the various stations.

In all the above stations video, audio and data is captured by the various devices, such as video camera, audio microphone, computer keyboard and the like. The information captured may be recorded locally or remotely. The information may be captured by one combined device such as a video camera having a microphone there within or independently by separate devices such as a microphone attached to the agent's computer, and a small video camera located in a hidden location. The agent's computer may also include a sound card or a microphone connected to a device coupled to a communications network, said device capable of transforming audio received by the microphone to data packets to be communicated. Such device is produced and manufactured by Way2Call Communications Ltd., Netanya, Israel. As will be shown later on the information captured can be analyzed in real time or off line at the request of an officer or controller. The analysis may seek discrepancies in the information the traveler provided agents or officers. The analysis also examines a traveler's record to see that the traveler has not skipped any one station which the traveler is required to go through. It may alternatively include an analysis of the video images or the audio record captured to see whether the traveler changed his appearance or collected different articles, such as a new handbag, or a an additional baggage and the like. The analysis may also identify the surrounding of the traveler, such as whether he is traveling with a companion and whether such person has left the traveler or continues to travel. The veracity of the traveler's statements may be identified by the analysis of the traveler's responses to the agents or officers, through the analysis of the interaction video or audio record. Reference is made in this connection to the related applications mentioned above relating to content analysis and solutions for walk-in environments. In addition, the interactions may be used for quality assurance purposes, in order to identify and correct agents or officers responses to various situations as well as for training of new agents and officers. Quality assurance interactions are reviewed to determine the quality of service provided by agents or officers. Quality assurance interactions are also reviewed to determine that the agent has followed a predetermined conduct, such as asking the appropriate security questions. Supervisors may establish a predetermined level of service the agent must meet. Such can include for example, a rule according to which the agent or officer must greet the traveler or request a particular detail. Supervisors of agents and officers may use the interactions to review the operation of subordinate agents or officers in real time. Such supervision may enhance efficiency and locate problems to be handled by officers at their outset thus increasing the travelers' satisfaction from the service provided. The system may analyze in real time interactions captured to determine if the agent or officer has met the predetermined level established by the supervisor. Off line quality management may be accomplished by supervisors filing evaluation forms on subordinate agents or officers while reviewing replays of the interactions captured along the traveler's path. Evaluation forms are forms, which contain scores, based on which score a training session may be assigned to agents in order to promote the agent's quality of service skills and to reward agents.

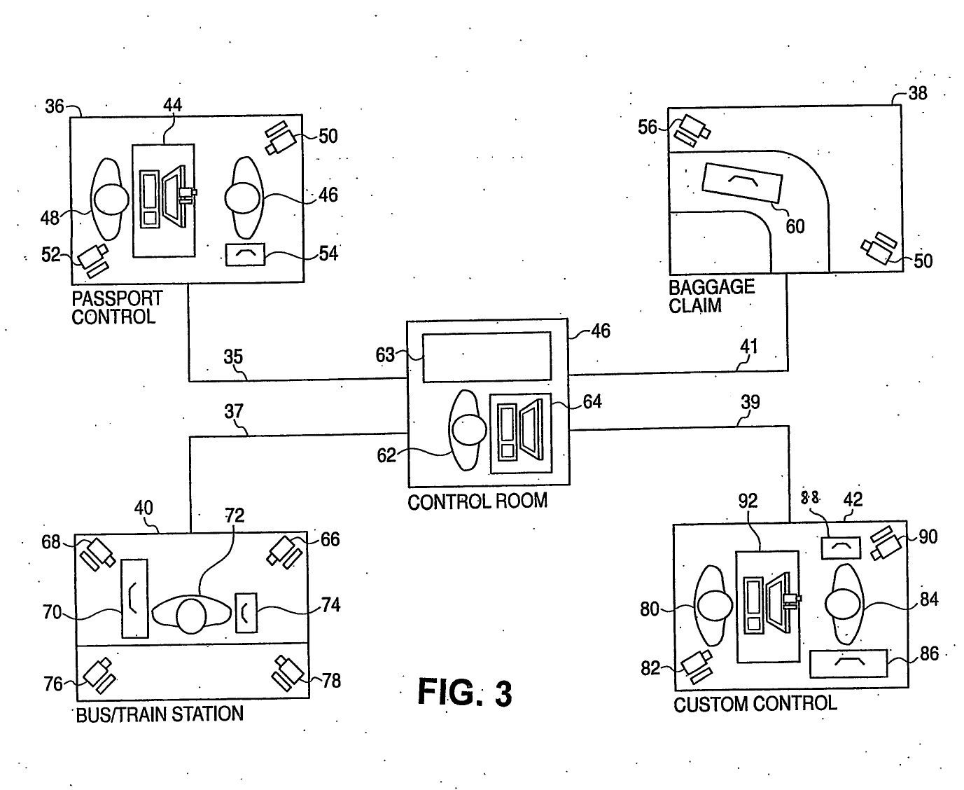

Referring now to FIG. 3 that illustrates a group of interaction capturing stations in a commercial airport or a transportation port. The stations 36, 38, 40, 42 are service and control stations, which are suitably distributed along a pre- defined “arrival” lane for disembarking travelers. The stations are operative in the handling of disembarking travelers where the handling includes the provision of specific services for the travelers, the implementation of specific legal and administrative rules, and for the provision of security through the successive monitoring of the agent-traveler-baggage interaction. The traveler is required to pass the stations 36, 38, 40, 42 in order to interact with the appropriate service and administrative agents that are responsible for the implementation of the specific legal and administrative rules and allow the traveler access to his port of destination. The stations 36, 38, 40, 42 could include locations external to the airport but closely associated therewith, such as a bus station or a train station or a sea port providing services for disembarking travelers. The stations 36, 38, 40, 42 are typically manned by service or administrative agents or security or control agents. The stations 36, 38, 40, 42 include various service or administrative-oriented devices or various security or control-oriented devices where some devices are useful for both service and control functions. These devices typically include computing devices with associated display screens, keyboards, microphones, and communication devices. Additional devices include video capturing devices, such as cameras, and the like. The stations. 36, 38, 40, 42 are linked to a control room 46 via a communications infrastructure, such as a network interface card, acoustic coupler, modem device, and wireless devices. Any of the communication devices may communicate to the control room 46 via LAN or WAN network, a cellular network, the Public Switch Telephone Network, a satellite network, a radio network and the like. The control room 46 typically includes a computing device operated by a human operator. Information collected at the stations 36, 38, 40, 42, such as traveler data, baggage data, video data, audio data, and the like is continuously transmitted from the stations 36, 38, 40, 42 to the control room 46 or to another remote location in order to be recorded, integrated, stored, monitored, and optionally retrieved. As explained in association with FIG. 2 the interaction captured and recorded may be analyzed in real time or off line. The analysis is primarily designed to locate discrepancies in the traveler's related information and record. The analysis is also designed to identify alert-related situations and alert agents and officers to a discrepancy or an alert, which may constitute a security hazard. Alternatively, the analysis may assist in the quality assurance process ensuring travelers receive appropriate service from agents or officers and evaluating performance. The system and analysis may also assist supervisors to maintain and control a large number of agents. The location depicted in FIG. 3 may be located in a location remote from the location depicted in FIG. 2. The two locations may be two different airports, bus stations, sea ports or the like or any combination there of. The two may be located in a single state country or continent or on different ends of the world. In accordance wit the present invention the two may share the same control room or have separate control rooms linked via communications network. The two may share the same database. Thus, analysis on interactions captured in the departing location can be used for analysis in association with interactions captured in the port of arrival or destination. In between the two locations interactions may be captured aboard the vehicle of transportation, whether it is an aircraft, a car, a train, bus or sea vessel. Such vehicle may have its own control room or transmit the interactions to a remote control room to be shared by the various control rooms distributed across states, countries or the world.

Still referring to FIG. 3, station 36 is a passport control point that includes a passport control agent 48. The agent 48 operates a computing device 44. The device 44 is typically a desktop computer with associated input/output devices, such as display screen, keyboard, pointing device, and microphone. Passport control officers may have a computer linked to various national and international databases, which may assist in the identification of a traveler and pervious entries or departures made by such an individual. The agent 48 interacts with the traveler 46 and enters the information acquired during the interaction into the device 44 for the purposes of validation and the like. The information is suitably formatted into computer-readable traveler data and is sent via a communication line 35 to the control room 46 in order to be processed, stored, monitored, and retrieved where needed. Station 36 further includes several video cameras 50, 52 that record a set of sequentially ordered video images that capture the agent-traveler interaction. Thus, the set of images capture the visual characteristics of the traveler, such as face features and characteristics, texture information such as clothing, hair color, personal items carried (for example, baggage 54) and the behavior patterns of the traveler 46. The captured sequence of images is transmitted via the communication line 35 to the control room 46 in order to be integrated with the traveler 46 record. Station 38 is a baggage claim point that includes a moving belt mechanism carrying baggage 60 that enables a traveler to collect the baggage 60. Station 38 further includes several video cameras 56, 58 that record a set of sequentially ordered video images that capture the interactions of the travelers (not shown) with the baggage 60. Thus, the set of images capture the visual characteristics of the traveler, such as clothing, hair color, the type of baggage 60 interacted with and the behavior patterns of the travelers. The captured sequence of images is transmitted via the communication line 41 to the control room 46 in order to be integrated selectively with the traveler record. Station 42 is a custom control point that includes a custom agent 80. The agent 80 operates a computing device 92. The device 92 is typically a desktop computer with associated input/output devices, such as display screen, keyboard, pointing device, and microphone. The agent 80 interacts with the traveler 84 and the associated baggage 88, 86 for custom checking purposes. The agent 80 enters custom-specific information acquired during the interaction into the device 92. The information is suitably formatted into computer-readable traveler data and is sent via a communication line 39 to the control room 46 in order to be processed, stored, monitored, and retrieved where needed. Station 42 further includes several video cameras 82, 90 that record a set of sequentially ordered video images that capture the agent-traveler interaction. Thus, the set of images capture the visual characteristics of the traveler, such as clothing, hair color, personal items carried (baggage 86, 88) and the behavior patterns of the traveler 84. The captured sequence of images is transmitted via the communication line 39 to the control room 46 in order to be integrated with the traveler's 84 other data. Station 40 is a bus or train or taxi station located in the vicinity of the port of destination. Station 40 could be a train station's waiting room, a train-boarding platform or a bus stop, a taxi line or the like. The station 40 is operative in capturing video information concerning the characteristics, and the behavior pattern of a traveler 72. For example, the video information reflects the fact that the traveler 72 carries two pieces of baggage 70, 74. The capturing of the information is achieved by he operation of four video cameras 68, 66, 76, 78 that cover the entire scene. The captured video images are sent via the communication line 37 to the control room 46 to be integrated selectively with other data concerning the traveler 72. The various capturing abilities as well as data and information sharing with stations located in the port of arrival are enhanced by a connection to a central station as well as directly to the port of departure. The same operational capabilities noted above in respect of the exemplary stations shown in connection with FIG. 2 are also likewise present in association with the exemplary stations of the present FIG. 3.

Still referring to FIG. 3 the control room 46 is manned by a system operator 62 or an agent or an officer, which may be a law enforcement officer or the like. The control room 46 includes a computing and communications platform device 63 and an associated display and input device 64. Captured data from the 36, 38, 40, 42 is transmitted to the control room and stored in the computing and communicating device 63. The operator 62 monitors the activity of the system by the display device and interacts with the system via the input device 64 and the computing and communicating device 63. The interaction could include defining and introducing system parameters, monitoring the proper operation of the system, activating or de-activating some or all of the components of the system, selectively monitoring the audio or data sent by a specific video camera or microphone respectively, responding to an alarm in pre-defined manner, communicating with the various service and control stations, communicating with external resources (law enforcement agencies), setting predetermined rules and actions for the control system to follow, and the like. The control room 46 may be located in the port of destination or remotely there from as is described in association with FIG. 2.

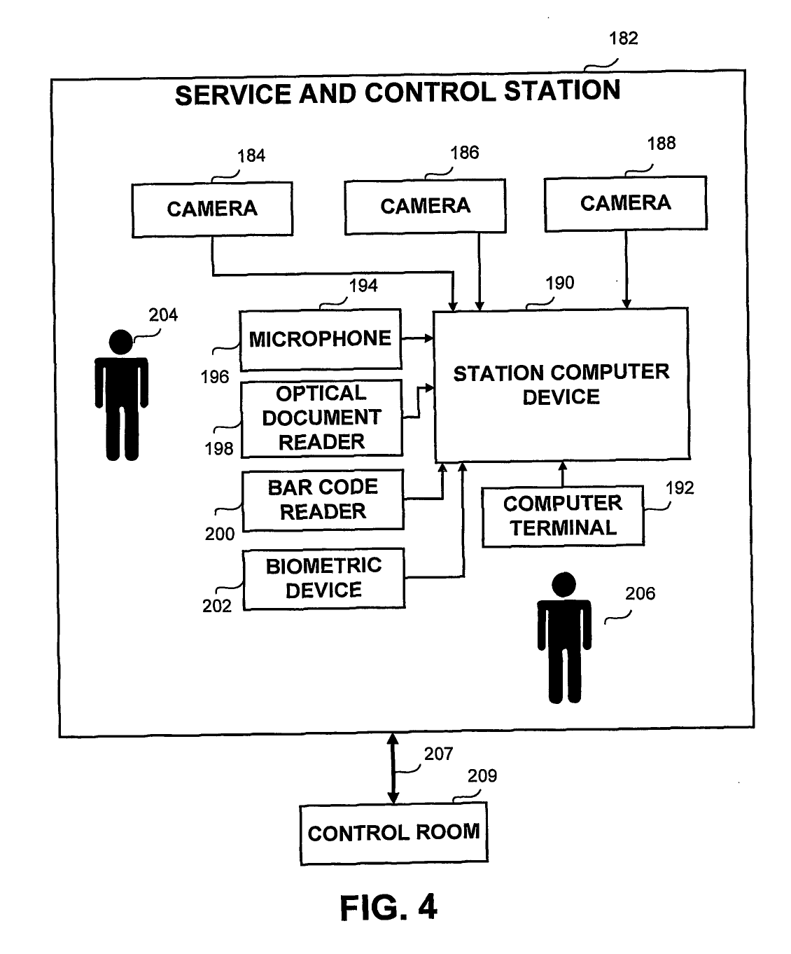

Referring now to FIG. 4 that generally illustrates the devices of a typical service and control station. Station 182 is operative in processing a traveler 206 where the processing may include: a) providing a specific service to a traveler, b) implementing specifically pre-determined legal or administrative procedures concerning the traveler 206, or c) monitoring the interaction between an agent 204 manning the station 182. The traveler 206 processed by the station 182, or a baggage belonging to the traveler 182. The monitoring is accomplished by capturing verbal or audio data, textual data, and visual data associated with the interaction and sending the collected data to a control room or to a remote location. A remote location may substitute the control room or also be used for redundancy purposes. The station 182 is manned by an agent 204, such as a police officer, security officer, ticket seller, ground attendant, carrier attendant, and the like. In accordance with the specific functions of the station 182 the agent 204 could operate a station computer 190 though the manipulation of various input/output devices, such as a computer terminal device 192, a microphone device 196, an optical document reader device 198, a bar code reader device 200, a biometric device 202, and the like. The agent 204 interacts with the traveler 206 typically in a verbal manner, and through the exchange and review of appropriate documents. At specific stations the traveler's baggage is separated from the traveler 206 to be processed separately. At other stations the traveler collects the baggage. At some stations the baggage is opened for examination or screened for forbidden items, such as examination for metallic or chemical reactive objects or explosives. The agent-traveler and the agent-baggage or baggage or traveler passage of specific predetermined points interaction is recorded visually or otherwise by a set of image acquiring devices, such as video cameras 184, 186, and 188. As noted above X-ray imaging may also be employed along with the screening database or stored information, as well as other means of imaging such as explosives screening, metal detectors, and the like. A microphone device 196 may also aurally record the agent-traveler interaction. The information collected by the agent and by the various devices is introduced into the computing device, is processed and formatted into computer-readable format. The formatted data is sent via a communication line 207 to a control room 209 or to a remote control destination in order to be recorded, processed, integrated with the traveler 206 record, stored, and optionally retrieved. Note should be taken that the audio images could be sent to the control room via a separate communication channel. Each agent or officer at a service and control station 182 may also receive information (such as data, video or audio) at his station computer device 190 from the control room 209. Such information may include alerts, notifications, processed information analyzed showing a particular discrepancy with the traveler supplied information, providing instructions from a supervisor or law enforcement agencies (such as to hold a certain person), providing training tips or a request to fill a feed back form for the purpose of training or quality assurance and the like.

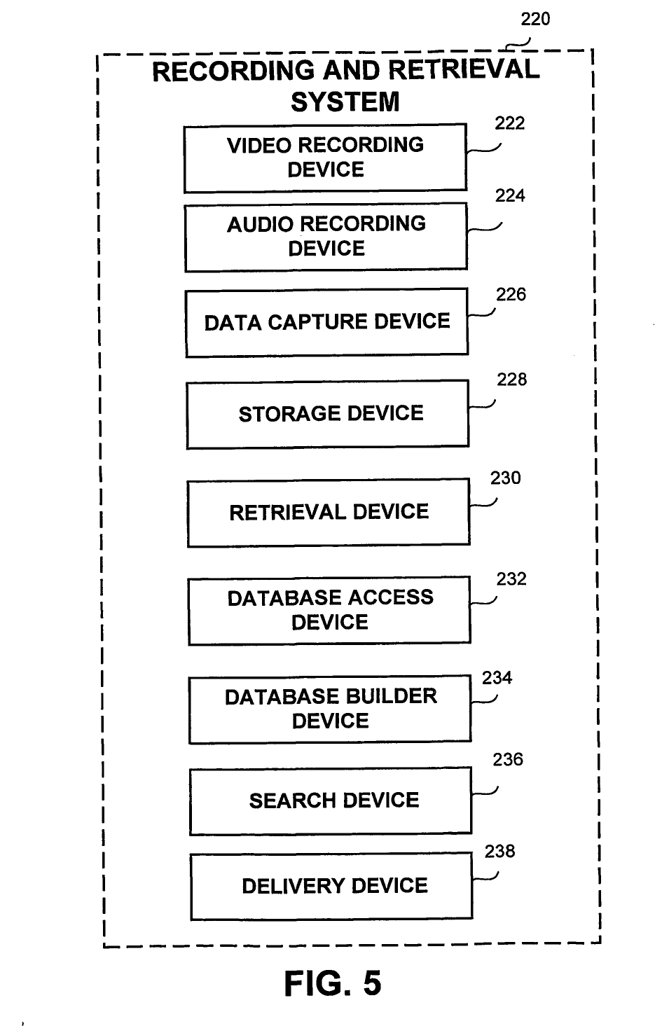

Reference is made now to FIG. 5 describing an exemplary device of the recoding and retrieval. The system 220 may be located at or near a port or in a remote location. A number of systems 220 may service one or more ports at the same time for redundancy purposes. The system 220 includes the following devices: 1) Video recording device 222 for recording video data from a plurality of video cameras located at specific service and control stations. The video recording device comprises a computerized device having high computation ability. Such device may be use a number of DSP chips to process information, data, audio and video simultaneously. One such system can be the NiceVision system of Nice Systems Ltd. of Ra'anana, Israel capable of providing fast synchronized video and audio logging. The recording module sending data to a recorder such as a tape, DAT tape, and hard disk or to any other known storage or logging device accomplishes recording. Data may be compressed prior to recording. The recording device can allow the recording of data together with recording related information such as the time of recording, channel number, frame per sec, metadata and such similar and related information. 2) Audio recording device 224 for recording audio data from a plurality of microphones located at specific service and control stations. The video and audio recording devices can comprise a single recording device or module for recording both video and audio. 3) Capturing device 226 for capturing data from a plurality of computer screens located at specific service and control stations. Data from computer screens may be captured in response to screen events as further described in the related patent applications listed above. Capturing data from computer screens is accomplished by the capturing module accessing the memory device of the computer screen and retrieving the computer screen information. Capturing computer screens can be accomplished by the NICE Universe product produced by Nice Systems Ltd. of Ra'anana, Israel. The agent's software (such as a CRM like software) will likely include fields in which the agent will insert his comments as to the traveler or fulfill important data about he traveler, such as language skills, general behavior and so forth. In addition, capturing device 226 may collect answers to various security-related questions. These questions can be later reintroduced to a traveler at a second or third station and the answers compared to detect discrepancies. Such can include for example information about the traveler's baggage or companions of travel or destination or origin of trip. Various notes made by each agent may also be stored to include general impression of the traveler or his baggage or companions, specific issues to be noted to by subsequent stations, other pertinent information not recorded elsewhere as well as suggestions for system improvements, training tips, special agent requests from supervisors, and the like. The system will enable an agent use this device to send a supervisor or a controller specific real time requests for intervening with a situation, such as when the traveler is suspicious, behaves in a suspicious manner, fails to comply with security related instructions, or where additional supervisor intervention is required to resolve a service or training issue. Likewise direct contact with law enforcement agent can be easily implemented in case an agent detects a serious security hazard or discrepancy. 4) Storage device 228 for storing the data captured and the recordings. The recording and data capturing operations are synchronized on the same time base. A storage device 228 is available to system 220 for long-term data storage. Such storage device can be a hard disk, tape, RAID, DSP and the like. The data captured and the recordings may be stored in associations with various parameters. Such parameters may include the time of recording, the date of recording, channel number, retention period, migration path, position, and the like. 5) Retrieving device 230 for retrieving data recorded by the system and storing the retrieved data on storage device 228. The data recorded and captured can be stored according to various key features such as, for example: time, date, user ID, station, traveler ID, suspicious events types, discrepancies types, a combination of one or more keys and the like. 6) Additional capturing device (not shown) for capturing data from a plurality of devices related to security and identification such as, for example bar-code tag readers, optical document readers, biometric devices (face, eye-scan, palm print), metal detectors, x-ray devices, explosives detection devices and the like. 7) Database access device 232 for accessing and communicating with external databases located locally or via a data communications network. Accessing and communicating with external databases can be accomplished through the use of a communication device such as a modem device, LAN/WAN network adapters, and other like devices. Accessing a local database is accomplished using standard Open Data Base Connectivity (ODBC) or using Link Server technology and the like. 8) Database building device 234 for building a database in storage 228 of the information gathered and recorded in respect to each traveler. Building a database is accomplished by entering the traveler related data into the database according to various key features such as: time, date, user or agent ID, station ID and the like. This device can also perform an automatic analysis of the information captured and recorded. If the analysis meets certain rules the system may send alerts or warnings to agents and security personnel and or directly to the police. Each time an interaction is captured and recorded it is analyzed individually and in relation to previous or other interactions. The interaction may be analyzed to determine discrepancies, security issues, quality assurance issues, and the like. Various rules can be implemented in the analysis process. Such can include rule relating to the content of the interaction itself, such as the length of the interaction, the parties involved, words said and spotted, stress detected, images captured and the like, or to the relationship between interactions. For example, when a traveler checks in to a flight destined for a particular port with a short return date but has an oversized baggage an alert can be issued for a discrepancy in the size of the baggage and the agent will be asked to refer the baggage for additional examination or request additional details from the traveler. Other alerts can be generated in response to numerous discrepancies, which may occur. Another non-limiting example is where a traveler checks-in to a flight having a particular handbag and later at the boarding he or she carries a different handbag. In such example, the system receives an image of the handbag at the boarding station and compares the shape, size, texture, and other features of the handbag with those previously captured at check-in. An alert may be issued directly to law enforcement agencies or to the agent to stop boarding. Likewise discrepancies relating to information about the purpose of travel, destination, documents of travel and other issues may be detected in real time and assist agents and law enforcement agencies to curtail attempts to perform a crime. In addition, analysis of agents may assist in quality control and assurance in the performance of such agents or officers. In addition, the analysis may be used for training agents or officers through the analysis of the performance of the agents or officers and providing real time feedback. One example is to remind an officer or agent to ask a question, which is mandatory. Another example is to remind an agent to check and verify particular details in a travel document. Yet another example is to request a traveler to open his hand bag or to provide an agent with e a list of instructions when baggage are to be referred for additional screening. Persons skilled in the art will appreciate the additional uses for the analysis of the information, data, audio and video captured. Reference is also made to PCT patent application number PCT/IL02/00593 for METHOD, APPARATUS AND SYSTEM FOR CAPTURING AND ANALYZING INTERACTION BASED CONTENT, filed 18 Jul. 2002 providing various other details as to the available options for content analysis. 9) Searching device 236 for enabling an operator at the control room to search the database for a specific traveler, follow the traveler's itinerary in the airfield or other locations, and correlate certain data items to find discrepancies. 10) Delivery device 238 for sending selected information retrieved from the traveler's database to one or more of the service and control stations along the itinerary of the traveler. It is further contemplated that if during off line analysis a potential suspect is detected, the delivery device 238 generates a report to third parties describing the suspect along with a video image and any other information which may assist in the identification and arrest of such an individual.

The system of the present invention can be implemented in association with a software system'such as NiceVision® (Suit) by Nice Systems Ltd. of Ra'anana Israel. Nice Vision® is a digital video recording system for the closed circuit TV security and public safety industries. NiceVision® provides facilities using multiple cameras with continuous multi-channel, high motion video and audio digital synchronized recording and tools for video data retrieval. The person skilled in the art will appreciate that the system and method described herein can be linked and used in conjunction with integrated security knowledge management solutions such as a full access control system, which can serve as partial infrastructure for the present invention. One example of such a system is the OnGuard Access system manufactured by Lenel System International, Pittsford, N.Y.

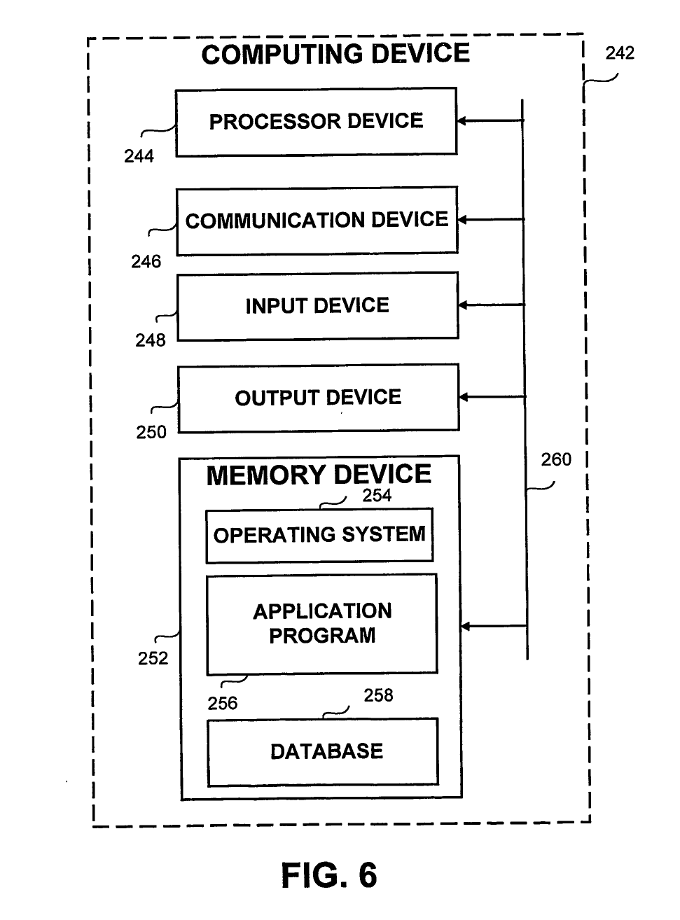

Referring now to FIG. 6 that shows a computing device operative in the execution of the recording and retrieval system. The computing device 242 is a hardware platform with computing and communications capabilities. In the preferred embodiment of the invention the computing device 242 is located in a central control room. Data captured at the service and control stations is transmitted to device 242 via a communication infrastructure, such as dedicated communication lines, a LAN network, a WAN network, a WLAN network, a POTS network and the like. The captured data is received by device 242 recorded, processed in a suitable manner and stored in an organized manner in order to enable the operators of the device to retrieve selectively the stored record for analysis, follow up and re-transmission to other local or remote computing devices in the network. In other preferred embodiments several computing devices 242 could be distributed in the network. The device 242 includes a processor device 244, a communication device 246, an input device 248, an output device 250, and a memory device. The devices 244, 246, 248, 250, and 252 communicate through a data bus 260 that connects the respective devices. The memory device 254 is preferably a hard disk. The memory device 254 includes an operating system 254, a recording and retrieval application 256 and an associated database 258. The processor device 244 can include a bank of DSP chips for rapid processing of data and information enabling the processing power required for the online analysis contemplated by the present invention. Additional processor device can be linked to achieve the processing power required.

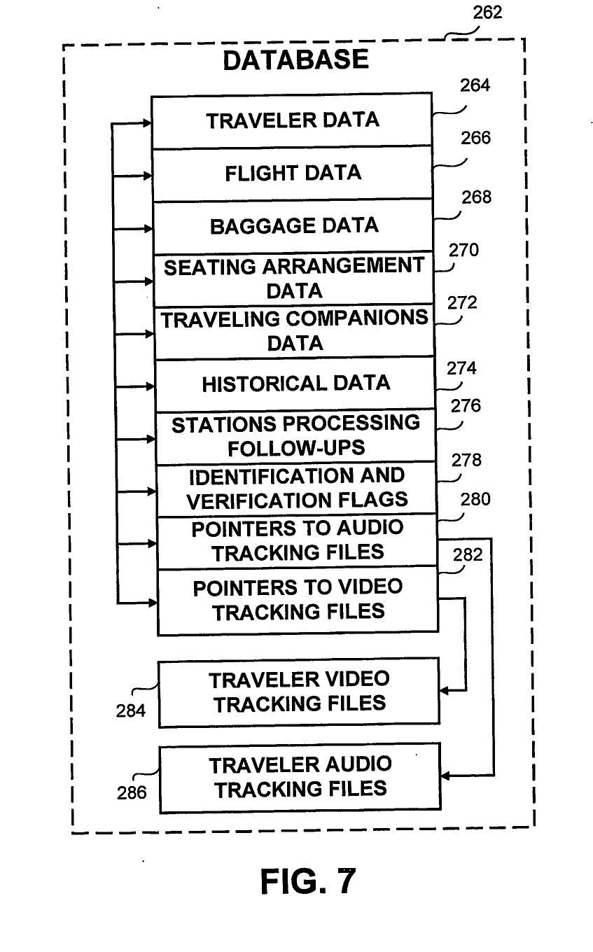

Referring now to FIG. 7 the database 262 stores the captured information that is sent from the various service and control stations. The information includes textual data, video data, audio data and other information pertaining to the interaction between the traveler and the agent or officer. The data is stored in the database 262 in a pre-defined structured manner. An integrated data record is built for each traveler handled by the system. The traveler record is generated successively and gradually over time as a result of the capturing of the traveler-specific information acquired through the various agent-traveler, agent-baggage, traveler-baggage, traveler, and baggage interactions that take place at the various capturing locations. The database will preferably include the following information: a) personal traveler data 264, such as name, address, personal identification number, nationality, profession, answers to questions at each station, various notes about the traveler, and the like b) itinerary data such as flight data 266, such as airline (or other carrier), flight number (or train or bus numbers), destination port, time and date of travel, length of travel, hotels of travel and contact information pertaining thereto and the like, c) baggage data 268, such as number of baggage pieces, type of baggage pieces, station-specific flags indicating whether the baggage was processed by the appropriate stations (screening), handbag data, size, color, weight, baggage internal imaging and the like, d) seating arrangement data 270, such as class and seat number, e) traveling companions data 272, such as the number of companions, pointers to the stored records of the companions, f) historical data 274, such as the number of traveler-specific historical records, and pointers to the historical records, g) stations processing follow ups 276, such as a list of stations the traveler is obliged to pass as well as suitable flags indicating whether the traveler was processed by a specific station, h) identification and verification flags indicating whether the information provided by the traveler was cross-checked against local or remote data sources and whether the information was appropriately verified, i) software pointers 280 to the audio files tracking the traveler during the various interactions, and j) software pointers 282 that link the traveler record to the relevant video files storing visual data associated with the tracking the traveler during the various interactions. The traveler record in the database 262 is linked through the above mentioned software pointers to related separately stored traveler video tracking files 284 and traveler audio tracking files 286.

The above-described structure of the database is exemplary only and was provided for ready understanding of the present invention. Various additional database elements could be added, some of the elements could be combined, and some of the elements could be dropped following the reduction to practice of the invention.

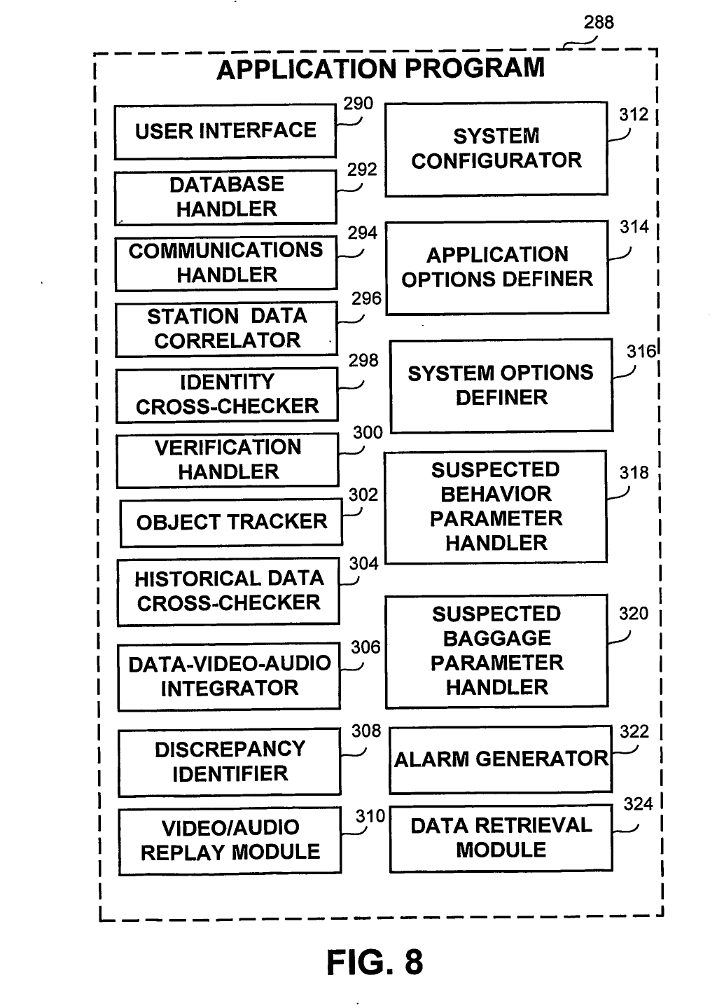

Referring now to FIG. 8 showing an exemplary application program of the present invention. The application program 288 may include all or part of the following modules: a user interface module 290 for providing a friendly user interface for agents, officers supervisors and controllers, a database handler 292 for handling database to application communication and data transfer, a communications handler 294 for providing communications abilities to the application program, a station data correlation module 296 for correlating the data provided by any station, an identity cross-checker module 298 for verifying the identity of a traveler through the examination of data provided and documents presented and through cross checking with national or international available data, a verification handler 300 for verifying data and images are as described by an agent or an officer, an object tracker 302 for tracking an object such as a baggage or a traveler in the various interactions recorded in the system, a historical data cross-checker 304 for cross checking interactions captured with previously recorded and stored interactions in relation to the traveler, a data integrator 306 for integrating the various data types and file types captured by the system, a discrepancy identifier 308 for identifying discrepancies arising from interactions captured, a video/audio replay module 310 for providing replays of video or audio files associated with interactions captured by the present invention, a system configuration module 312 for configuring the system or station within the system such as defining rules and actions as well as adaptive calibration throughout the use of the system, an application options definer module 314 for determining the application pre-selected options, a system options definer module 316 for determining the system pre-selected options, a suspected behavior parameter handler 318 for providing and handling the various suspicious events relating to travelers, a suspected baggage parameter handler 320 for providing and handling the various suspicious events relating to baggage, an alarm generator 322 for providing an alarm to an agent, office, controller or supervisor, and a data retrieval module 324 for accessing databases and retrieving data. Note should be taken that the above-described program components are exemplary only. Various additional program modules could be added, some of the modules having different functionality could be combined and some of the modules could be dropped following the reduction to practice of the invention.

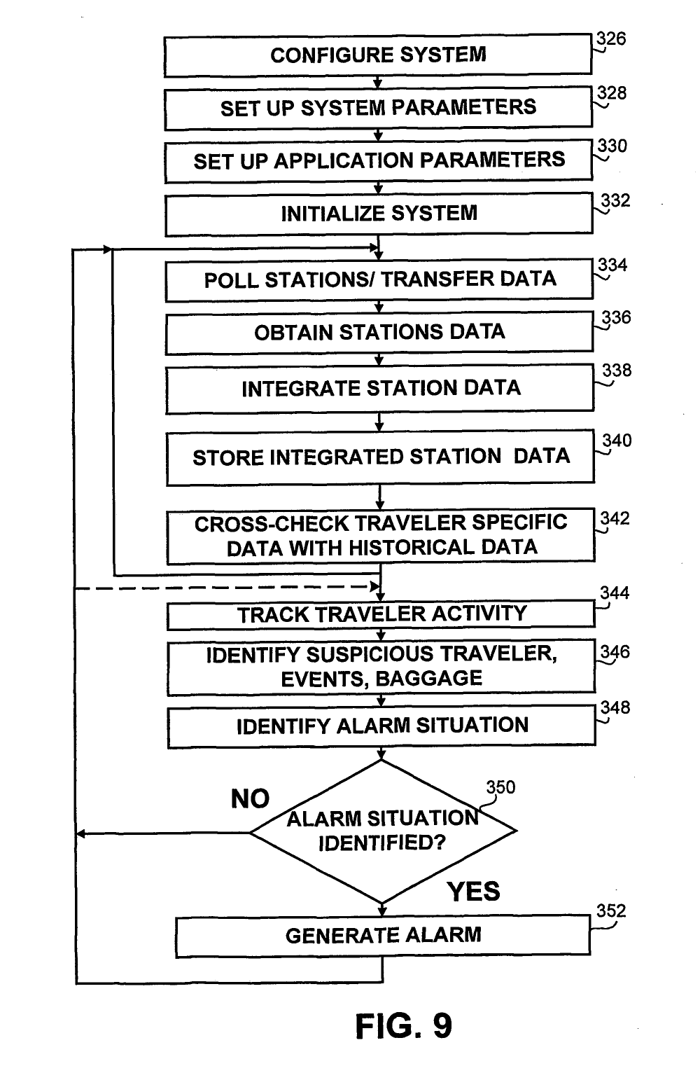

Referring now to FIG. 9 that illustrates the operational flow of the application. Across steps 326 through 332 the system is configured, adapted to environment constraints and parameters are initialized. Steps 326 to 332 are typically executed before the activation of the application. At step 326 the operator of the system configures the system. System configuration involves various definitions concerning the physical infrastructure and the interaction capturing components that constitute the system. For example, system configuration could involve defining the number of service and control stations with interaction capturing capabilities, the type and number of capturing devices associated with each station, the alternative ordering of the stations in respect to the progressive processing of the traveler during the departure and the arrival process respectively and priority setting. In one example, a boarding station is allotted additional computation power and resources so as to enable instantaneous analysis of the information and data captured in such station. At step 326 definitions are performed concerning access and interaction with local and/or remote data sources. At step 328 various system parameters are defined, such as the type of checks to be performed, and the like. At step 330 the application parameters are set up. Application parameters could involve the type of discrepancies, suspicious events, alarm to be generated, appropriate station operation procedures, training procedures and the like. At step 332 the system is initialized by the loading of the various program modules, by the opening of the database, and the like. The loop across steps 334 through 342 deals with the recording of the data captured at the interaction capturing locations. At step 334 the various pre-defined stations with interaction capturing capabilities are polled for the availability of appropriate captured interaction data. Alternatively the pre-defined stations transfer captured information, data, video and audio so that polling is not required. At step 336 the captured interaction data is received from the stations. At step 338 the data received in various formats is integrated and at step 340 the integrated data is stored in the database. At step 342 cross-checks are performed on the interactions captured through the use of traveler-specific data, historical interaction data, local data sources and remote data sources. Consequently program control proceeds to step 334 to continue to execute the program loop across steps 334 through 342. The program loop of steps 334 through 342 are executed continuously irrespective of other events in the system including alarm situations. The program loop steps of steps 334 through 342 represent the continuous capturing of video, audio, data and information from the various stations. The program loop across steps 344 through steps 350 is performed in order to track the activities of a traveler, a baggage, a handbag, a companion of the traveler, to identify discrepancies or suspicious events or quality assurance issues and to raise an alarm if applicable. The program loop across steps 344 through steps 350 is performed irrespective and independent to the program loop across steps 334 through 342. At step 344 the activities of the traveler or baggage or agent or officer are tracked. At step 346 attempts are made to identify discrepancies, suspicious events concerning the traveler and the traveler's baggage or companions through analyzing interactions and available data (which may include previous interactions). The analysis of interactions is dependant on the interaction captured and the station capturing the data. Each station-captured interaction is associated with specific analysis steps designed to enable specific analysis of the interaction captured therein. The various parameters provided by the traveler, the baggage, handbag, or companions of the traveler are analyzed at each station. The analysis comprise of identifying the parts of the interaction, such as traveler provided data, video or audio and performing a sequence of examinations or analysis on each part. The data or information provided by the traveler is analyzed to see that it complies with previously provided data or information and that no discrepancies exist. If for example the name provided at a first station is different from the name provided in a second station a discrepancy exist. Likewise if a first travel document is used in one station and a second travel document is used in a second station than a discrepancy exits. Video is analyzed to see that the traveler baggage is safe and is the same baggage associated with the traveler so that baggage is not transferred from one traveler to another. The same video may be analyzed to determine the features of the traveler's face and clothing to continuously verify that the same traveler is associated with the same travel documents and baggage. Audio and video recording of the traveler may determine if the traveler is under stress or lying. Information may also be used to identify quality assurance issues, relating to the performance of the agents or officers. If an agent does not provide the required information to the traveler or fails to follow procedures for handling the traveler an alert may be issued directly to the traveler or to a supervisor. For example, if an agent fails to ask a security question, note the answer in the system or fails to issue a boarding card. At step 348 as a result of the identification of a discrepancy or suspicious event or quality assurance issue a pre-defined alarm situation is identified and processed. At step 352 it is determined whether an alarm situation was identified. If the result is positive then at step 352 an alarm is generated, the specific alarm is raised in the pre-defined manner associated with the associated alarm and program control proceeds to step 344 to perform a program loop across steps 344 through 350. If no alarm situation was detected at step 350 then the execution of step 352 is skipped and program control directly proceeds to step 344 to perform the program loop of steps 344 through 350.

Note should be taken that the above described flow chart is extremely simplified to provide for the ready understanding of the program operation. A plurality of additional steps could be implemented, such as flight data validation, and the like. Step 346 could involve a plurality of sub-steps, such as recognizing a discrepancy in the number of traveler's companions among the various stations, identifying a discrepancy in the number of baggage pieces, loosing track of the traveler between stations, and the like.

A Local Area Network (LAN), a Wireless Local Area Network (WLAN) or any other type of local area networks can be used in the airport area to connect all the stations and the control room. The network will be also connected to a Wide Area Network, such as the Internet or any other suitable communications network, by which the system communicates with relevant data sources located anywhere in the world. Such data sources could be local police files, Interpol or FBI files, national or international databases and the like. The same LAN permits the operators of the system to communicate by electronic mail with other security facilities to get information or clear certain issues. The present invention is also operative to issue warnings and alerts in real time, which are issued in response to rule-based analysis performed by the system. The rule-based analysis can be based upon certain predetermined or adaptive profiles.

Persons skilled in the art will appreciate that at least one or a plurality of stations can be employed in association with the present invention. Similarly, more than one control room or communications network are contemplated by the present invention. In the preferred embodiment of the present invention, several stations as well as the control rooms are located within the airport, while other stations or control rooms might be inside or outside the airport, close by or remotely located.

To better facilitate the understanding of the present invention, an example of the operation of the present invention is provided next. In order to describe a typical series of agent-traveler interactions the following scenario will be assumed. The ticket purchase station is equipped with at least a computer, a microphone and a digital video camera. These devices, equipped with interfaces, feed data to the system of the present invention installed in a control room located remotely to the stations. The same devices are installed in each station. The traveler purchases a ticket for travel as per his personal details. The baggage screening station is equipped with baggage screening equipment, with or without an agent, and one or more digital cameras. The baggage screening station may include its own database. These devices, equipped with interfaces, feed data to system installed in the control room. The check-in station is equipped with at least a computer, a microphone and a digital video camera. These devices, equipped with interfaces, feed data to the system installed in the control room. At the check-in station a tag is given to the traveler for personal identification. The tag could be for example, a boarding card marked by a printed bar code, or a bar-code sticker attached to the boarding card or any other like marking that may identify the tag. Other possibilities are biometrics or electronic identification means that could be subsequently be read by the agents in such additional stations where the traveler passes through. The information in the tag is automatically transmitted to the control room in purpose to open a personal traveler's file in the database of the system. The passport control station is equipped with at least a computer, a microphone and a digital video camera. These devices, equipped with interfaces, feed data to system installed in the control room. In the passport control station additional identification equipment could be installed such as, for example, passport validation readers. The passenger screening station is equipped with a hand baggage and passenger screening equipment, with an agent, and a digital camera. These devices, equipped with interfaces, feed data to system) installed in the control room. The boarding station is equipped with at least a computer, a microphone and a digital video camera. These devices, equipped with interfaces, feed data to system installed in the control room. The traveler is likely to go through some or all of the stations, as per the directions valid at the specific port. While going through the specific stations traveler is manually or automatically identified by his tag and data is collected at the station, communicated to the system and stored in database in the travelers' personal file stored in the database. Such data could be, for example: a) At ticket purchase station, details known to the agent about traveler such as address, passport number, mode of payment for the ticket, previous transactions at the same stations, and video and audio recordings of the present transaction, and the like, b) At the check-in station, details of the seating in the vehicle of transportation, baggage weight and identity, hand baggage to be hand carried by the traveler and video and audio recordings of an “event”, c) At the passport control station, details on the passport presented by the traveler, results of any checks done by the passport officer and the video and audio recordings of the conversation between traveler and officer, d) At baggage screening station, screen capture of the traveler's baggage and video and audio recordings of the screening “event”.

The system stores data on the same traveler going through the process of boarding the airplane. Data is collected and updated once the traveler is processed at a specific station. A specific security application use the data stored in database to analyze, for example, the following data, having relevance on issues of flight security: a) Cross check the given identity and appearance of the traveler with databases of, for example, the Interpol or FBI related to “wanted” persons, b) Verify (tag and visual) that the same traveler passed all designated stations, c) Identify suspected behavior of traveler, d) Identify suspected luggage of traveler, e) Cross correlate the information collected at the stations for discrepancies, f) Cross check with previous travel interactions from other times or dates.

As noted above, the system can be used also for quality assurance of the interaction between agents and travelers. Because the agent-traveler interaction at specific stations is captured (video, audio and computer), a qualified examiner can review and analyze the records collected in the database and apply known criteria to grade the agents involved. The records in database, which reflect real life occurrences and behavior of both travelers and agents, can be used for training purposes of agents, operators and security personnel. The system can be used for other purposes than supervision of airports, for example: central train stations, hospitals and secured installations. Moreover, once the system detects a quality assurance issue an automatic training program for the agent or officer may be activated when the agent is idle. Feedback forms may also be automatically directed to agents and officers and travelers once a specific procedure has been followed so as to provide supervisors and controllers with feedback as to the system's operation.

The person skilled in the art will appreciate that what has been shown is not limited to the description above. Many modifications and other embodiments of the invention will be appreciated by those skilled in the art to which this invention pertains. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

It will be appreciated by persons skilled in the art that the present invention is not limited to what has been particularly shown and described hereinabove. Rather the scope of the present invention is defined only by the claims, which follow.

1. An apparatus for the analysis of a captured interaction associated with a traveler and an agent, the apparatus comprising:
an at least one first station for capturing an at least one first interaction along a traveler path;
an at least one second station for capturing an at least one second interaction along the traveler path; and
an analysis device for comparing the at least one second interaction with the at least one first interaction.

2. The apparatus of claim 1 further comprising a control station for storing the at least one first and second interactions captured.

3. The apparatus of claim 1 further comprising an alarm identifier device for identifying an alarm situation based on the comparing of the at least one second interaction with the at least one first interaction.

4. The apparatus of claim 3 further comprising an alarm-generating device for generating an alarm associated with an alarm situation identified by the alarm identifier device.

5. The apparatus of claim 1 further comprising a station poll data device for polling stations for the at least one first and second interactions.

6. The apparatus of claim 1 further comprising a station transfer data device for managing data transferred from stations for the at least one first and second interactions.

7. The apparatus of claim 1 further comprising a database for storing and retrieving the at least one first and second interactions.

8. The apparatus of claim 1 further comprising a replay device for replaying at the least one first or second interactions.

9. The apparatus of claim 1 further comprising an object tracking device for tracking an object within the at least one first or second interactions.

10. The apparatus of claim 1 wherein the at least one first and second stations comprise at least one video capturing device, an at least one audio recording device, an at least one data capture device, an at least one storage device and an at least one data retrieval device.

11. The apparatus of claim 1 wherein the at least one first station and second station are located in the same transportation port.

12. The apparatus of claim 1 wherein the at least one first station and second station are located in remote transportation ports.

13. The apparatus of claim 1 further comprising a second control room for recording and storing the at least one first and second interactions.

14. The apparatus of claim 1 further comprising a local or remote operator for observing the operation of the apparatus.

15. The apparatus of claim 1 wherein the control station comprises a recording and retrieval system.

16. The apparatus of claim 1 wherein the capturing is performed in real time to be analyzed upon capture or at a later time.

17. The apparatus of claim 11 wherein the transportation port is an airport or a train station or a bus depot or a seaport or a vehicle for transporting persons.

18. The apparatus of claim 1 wherein the interaction is associated with a baggage item.

19. The apparatus of claim 1 wherein the at least one and second interactions comprise a captured data, video and audio depicting the interaction between the agent and the traveler.

20. The apparatus of claim 1 further comprising a quality assurance device for analyzing the at least one first or second interaction for analyzing the quality of service provided to the traveler by the agent.

21. The apparatus of claim 20 wherein the quality assurance device alerts a supervisor where the quality of service provided by an agent fails to meet a predetermined standard.

22. The apparatus of claim 20 wherein the quality assurance device initiates a training session with an agent.

23. A method for the analysis of a captured interaction associated with a traveler and an agent, the method comprising the steps of:
capturing an at least one first interaction at a first station along a traveler path;
capturing an at least one second interaction at a second station along the traveler path; and
comparing the at least one second interaction with the at least one first interaction.

24. The method of claim 23 further comprising the step of recording at a control station the at least one first and second interactions captured.

25. The method of claim 23 further comprising the step of storing at a control station the at least one first and second interactions captured.

26. The method of claim 23 further comprising the step of an alarm identifier device identifying an alarm situation based on the comparing of the at least one second interaction with the at least one first interaction.

27. The method of claim 26 further comprising the step of generating an alarm associated with an alarm situation identified by the alarm identifier device.

28. The method of claim 23 further comprising the step of polling the at least one first and second interactions from the first and second stations.

29. The method of claim 23 further comprising the step of retrieving the at least one first and second interactions from a database.

30. The method of claim 23 further comprising the step of replaying through the use of a replay device the at the least one first or second interactions.

31. The method of claim 23 further comprising the step of tracking an object within the at least one first or second interactions.

32. The method of claim 23 wherein the at least one first and second stations comprise an at least one video capturing device, an at least one audio recording device, an at least one data capture device, an at least one storage device and an at least data retrieval device.

33. The method of claim 23 further comprising the step of analyzing the at least one first or second interaction for quality assurance purposes.

34. The method of claim 23 wherein the at least one first station and second station are located in the same transportation port.

35. The method of claim 23 wherein the at least one first station and second station are located in remote transportation ports.

36. The method of claim 23 further comprising the step of recording and storing at a second control room the at least one first and second interactions.

37. The method of claim 23 wherein the control station comprises a recording and retrieval system.

38. The method of claim 33 wherein the step of analysis comprises comparing the at least first or second interaction to determine discrepancies in the interaction between the traveler and the agent.

39. The method of claim 33 wherein the step of analysis comprises comparing the at least second interaction with the at least first interaction to determine discrepancies between the second and first at least one interactions.

40. The method of claim 33 wherein the step of analysis comprises analysis of the at least first or second interaction to determine whether the traveler is a security threat to other travelers.

41. The method of claim 33 wherein the step of analysis comprising analysis of the at least second or first at least one interaction to determine if the agent is providing a quality of service at a predetermined level.

42. The method of claim 23 further comprising the step of transferring data from the at least one first or second stations to a server device.

43. A method for traveler interactions management
capturing information at predetermined locations along a traveler path;
recording the captured information;
storing the recorded information on a storage device, and
analyzing the recorded information.
